(19) United States
(12) Patent Application Publication
(10) Pub. No.: US 2009/0167604 A1
(43) Pub. Date: Jul. 2, 2009

(54) FAST TRAINING OF PHASED ARRAYS USING MULTILATERATION ESTIMATE OF THE TARGET DEVICE LOCATION

(76) Inventor: Richard D. Roberts, Hillsboro, OR (US)

Correspondence Address: COOL PATENT, P.C.;c/o CPA Global, P.O. BOX 52050, MINNEAPOLIS, MN, 55402, US

(21) Appl. No.: 11/967,302

(22) Filed: Dec. 31, 2007

(51) Int. Cl. H01Q 3/00

(52) U.S. Cl. 342/368

(57) ABSTRACT

Briefly, in accordance with one or more embodiments, a phased array antenna may utilize Multilateration in order to implement beam steering with a phased antenna array. During a training phase, Multilateration equations may be utilized to determine a coordinate location of an antenna of a target device. The time difference of arrival of the training signal may be determined at selected antenna elements of the antenna array. The location of the antenna of the target device may then be calculated from which the propagation time may be determined. The propagation time may then be converted to relative phase shift values for each antenna element in the array with respect to a reference antenna element. A beam may then be directed toward the antenna of the target device by setting the elements of the antenna array with the calculated phase shifts.

### BACKGROUND

Wired standards for coupling two or more devices are increasingly being adapted to provide wireless coupling between devices. An example of such a standard includes the Wireless High-Definition Multimedia Interface (HDMI) standard in which the higher data rates involved with Wireless HDMI may be implemented at or near 60 GHz provided that sufficient link margin exists to close the link over the desired distance, which may be for example about 10 meters. Obtaining a sufficient link quality of these higher data rates at 60 GHz may involve controlling the transmission and receiving (TX/RX) antenna gains, and/or multi-element phased antenna arrays. Phased antenna arrays having 24 or more antenna elements have been considered for application in the 60 GHz band.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a wireless network including a broadcast device having a phased antenna array for communicating with a target device in accordance with one or more embodiments;

FIG. 2 is a diagram of an example antenna array for phased array training in accordance with one or more embodiments;

FIG. 3 is a diagram of an example antenna array having four quadrants defined for performing multilateration in accordance with one or more embodiments;

FIG. 4 is a diagram of an example antenna array illustrating the utilization of multilateral equations to determine a distance from the antenna array to an antenna of a target device in accordance with one or more embodiments; and

FIG. 5 is a block diagram of an information handling system capable of using a multilateration estimate of a target device location in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

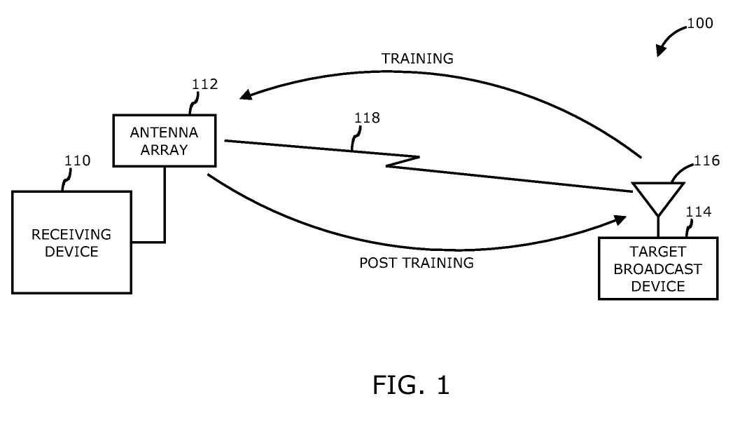

Referring now to FIG. 1, a diagram of a wireless network including a target broadcast device having a transmit antenna 116 for communicating with a receiving device in accordance with one or more embodiments will be discussed. As shown in FIG. 1, a receiving device 110 may include an antenna array 112 capable of receiving a radio-frequency (RF) signal 118 from a target broadcast device 114 having an antenna 116 capable of transmitting the RF signal 118. The receiving device 110 shall be capable of demodulating and decoding the information contained in the RF signal 118. In one or more embodiments, antenna array 112 may comprise a phased array of antennas capable of directionally receiving RF signal 118 as a directional beam. It should be noted that during training, target broadcast device 114 is doing the broadcasting and receiving device 110 is doing the receiving in order to implement passive beam forming on the receiving side at antenna array 112. Once the reception phased antenna array 112 is trained, it can then be used for transmitting to form a beam for transmitting a signal post training.

In one or more particular embodiments, receiving device 110 and/or target broadcast device 114 may comprise network elements on a wireless network 100, for example a 60 GHz Wireless Local Area Network (WLAN) and/or Wireless Personal Area Network (WPAN). In some embodiments, network 100 may be implemented in compliance with one or more standards or special interest groups, such as the European Computer Manufacturers Association (ECMA) TG20 standard for High Rate Short Range Wireless Communication or the like, the Institute of Electrical and Electronics Engineers (IEEE) 802.15.3c standard for WPAN Millimeter Waver for Alternative Physical Layer (PHY) or the like, the Wireless High-Definition (WiHD) or Wireless High-Definition Multimedia Interface (HDMI) television standards or the like, and so on, and the scope of the claimed subject matter is not limited in these respects. For example, in one or more embodiments, target broadcast device 114 may comprise a cable or satellite receiver capable of receiving a High-Definition television signal and then transmitting the High-Definition broadcast signal via RF signal 118 to receiving device 110 which may comprise a High-Definition television. In an alternative embodiment, target broadcast device 114 may comprise a personal computer or laptop computer, and receiving device 110 may comprise a computer monitor for receiving images to be displayed via RF signal 118. However, these are merely example embodiments for the elements of network 100, and the scope of the claimed subject matter is not limited in this respects.

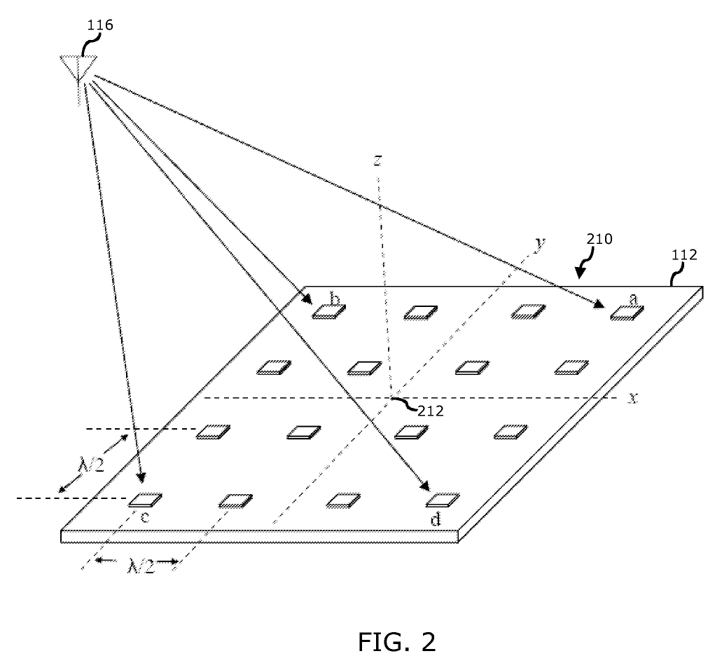

Referring now to FIG. 2, a diagram of an example antenna array for phased array training in accordance with one or more embodiments will be discussed. In the embodiment shown in FIG. 2, target broadcast device 114 is represented by its antenna 116, and antenna array 112 of receiving device 110 is shown comprising an array of individual antenna elements 210. In the embodiment shown in FIG. 2, antenna array 112 comprises a 4×4 array of 16 antenna elements generally spaced in a periodic, planar arrangement and being symmetrically disposed about a center 212 at a spacing of λ/2 where λ is the wavelength of the carrier frequency for which antenna array 112 may be designed. A coordinate axis may be defined having its origin coincident with center 212 of antenna array 112 with the x-axis and the y-axis lying in the same plane in which antenna elements 210 are disposed, and the z-axis being disposed normal to that plane. It should be noted that the arrangement of antenna array 112 as shown in FIG. 2 is but one example, and that other arrangements could likewise be implemented, and the scope of the claimed subject matter is not limited in these respects.

In one or more embodiments, in order for receiving device 110 to be able to directionally receiver the RF signal 118, a training phase for antenna 112 may be implemented in which four particular antenna elements 210 may be selected as the four corner elements, element a, element b, element c, and element d as shown in FIG. 2 to implement Corner Time Difference of Arrival (TDOA) Multilateration. First, target broadcast device emits a white sequence for which a cross correlation at antenna elements a, b, c and d produces a timing epoch. The time epochs are measured relative to a local clock disposed in the receiving device such that the time epoch is correct in a relative sense but need not be correct in an absolute sense. Next, a time difference of arrival (TDOA) may be determined at least in part from the timing epochs generated at elements a, b, c and d. The TDOA values may be generated by subtracting the relative time epochs to yield six TDOA metrics: Ta-Tb; Ta-Tc; Ta-Td; Tb-Tc; Tb-Td; and Tc-Td. If the cross correlation is done as a complex number, then carrier phase can be used to refine the TDOA estimate. In one or more embodiments, the complex cross correlation rotates 360 degrees for a time lag equal to the carrier period. For example, for a 60 GHz carrier, the cyclic period of the cross correlation is 60×10⁻⁹, although the scope of the claimed subject matter is not limited in this respect.

Next, the TDOA metrics may be utilized to calculate the location of the antenna 116 of the target broadcast device relative to the center 212 of the rectangular antenna array 112, which in one or more embodiments may be implemented via a technique referred to as Multilateration. The mathematics for Multilateration are known and straightforward, involving solving a set of hyperbolic equations for the x, y and z location of antenna 116 of target broadcast device 114 with respect to the coordinates of antenna array 112. Once we have the relative location of antenna 116 of target device 114 is determined with respect to antenna array 112, the distance from antenna 116 of target device 114 to each of the elements 210 in antenna array 112 may be calculated. For a 4×4 array example shown in FIG. 2, 16 distances may be calculated according to a the following formula:

dᵢⱼ={square root over (xᵢⱼ²+yᵢⱼ²+zᵢⱼ²))}

Each calculated distance may then be expressed as a propagation time based upon the speed of light according to the following formula:

$${t}_{ij} = \frac{{d}_{ij}}{c}$$

where c=the speed of light. Once the propagation times are known, the propagation times may then be converted to a propagation phase via a Fourier phase shift property formula:

θᵢⱼ=e^{-jω}^{ₒ}^{t}^{ᵢⱼ}

In one or more embodiments, the absolute phase shift of the above Fourier phase shift formula may be of less interest than the relative phase shift referenced to an element in the phased array, thus knowing the relative phase shift may be sufficient although the scope of the claimed subject matter is not limited in this respect.

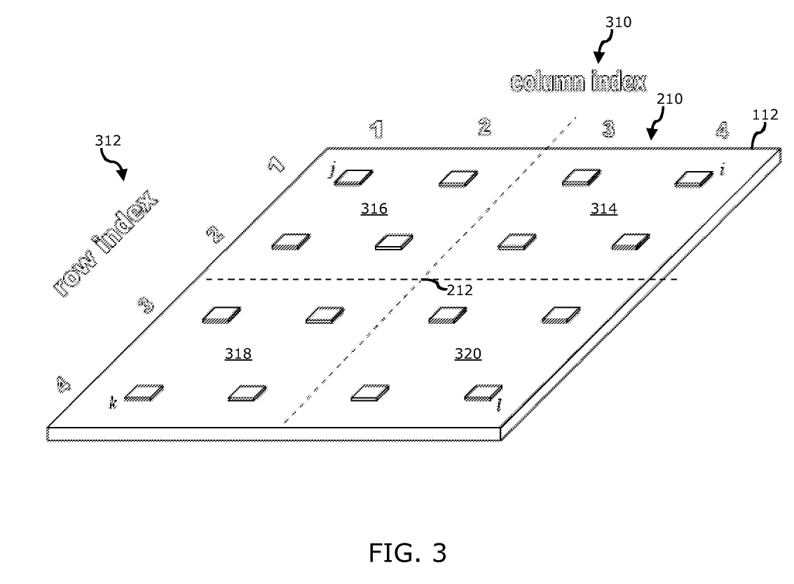

Referring now to FIG. 3, a diagram of an example antenna array having four quadrants defined for performing multilateration in accordance with one or more embodiments will be discussed. As shown in FIG. 3, to complete the training phase for antenna 112, array element <1,1> may be selected as the reference element for defining the relative phases of the other antenna elements 210 of antenna array 112. The phase difference matrix may be defined as:

Δθᵢⱼ=θᵢⱼ−θ₁₁ for i,j={1, 2, 3, 4}

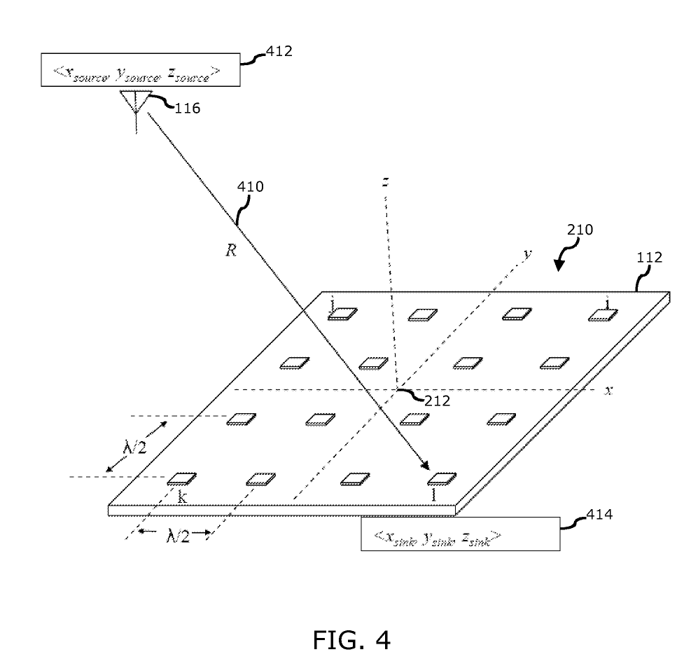

This phase difference matrix is then the desired final product for training antenna array 112 in that if each antenna element 210 is provided with the prescribed phase delta with respect to the reference element, then antenna array 112 will cast a reception beam in the direction of the training source, which is antenna 116 of target broadcast device 114. Thus, in one or more embodiments, a directional, phased antenna array 112 may receive the broadcasted RF signal 118 in a reception beam based at least in part on Phase Estimation via Corner TDOA Multilateration. Such an arrangement may result in a fixed overhead time for antenna training regardless of the number of antenna elements 210 in antenna array. The overhead time is a function of the time it takes to do the cross correlation at the four corners of the antenna array as shown in and described with respect to FIG. 1 and FIG. 2. This fixed overhead may result in faster training times for larger sized antenna arrays 112 at the expense of computational complexity in solving the multilateration equations as discussed with respect to FIG. 4, below. In addition, such an arrangement may facilitate more accurate hemispherical beam pointing within the phase accuracy of the phase shifting elements, although the scope of the claimed subject matter is not limited in these respects.

Referring now to FIG. 4, a diagram of an example antenna array illustrating the utilization of multilateral equations to determine a distance from the antenna array to an antenna of a target device in accordance with one or more embodiments will be discussed. In one or more embodiments, using a 4×4 array as an example, the following Quadrants of antenna array 112 may be defined as:

E_{Q1}=E_{1,4}=<xᵢ, yᵢ, zᵢ> Quadrant 1 corner element:

E_{Q2}=E_{1,1}=<xⱼ, yⱼ, zⱼ> Quadrant 2 corner element:

E_{Q3}=E_{4,1}=<xₖ, yₖ, zₖ> Quadrant 3 corner element:

E_{Q4}=E_{4,4}=<xᵢ, yᵢ, zᵢ> Quadrant 4 corner element:

Referring to the propagation phase equation based on the Fourier phase shift property discussed with respect to FIG. 3, above, it should be noted that cross correlation may be determined on a first operating frequency, and then the related relative phase shift may be calculated for a second operating frequency. Such a process may be utilized when training the antenna on a training channel, and then tuning the antenna to operate on a data channel that may have a different frequency than the training channel.

After defining the above quadrants, in one or more embodiments, the TDOA technique may be based at least in part on the equation for the distance between two points:

$$R = \sqrt{{( {x}_{source} - {x}_{sink} )}^{2} + {( {y}_{source} - {y}_{sink} )}^{2} + {( {z}_{source} - {z}_{sink} )}^{2}}$$

In the above equation, the source may comprise the coordinate location 412 of antenna 116 of target broadcast device 114, and the sink may comprise the coordinate location 424 of an antenna element of reception antenna array 112 during training. The distance R 410 between an emitting source, antenna 116, and a receiving sink, antenna array 112, may be determined indirectly by measuring the time it takes for a signal to reach broadcast device 110 from target device 114. Multiplying the time of arrival (TOA), t, by the signal velocity, c, results in the distance, R. Applying this process this the corner antenna elements 210 of antenna array 112 yields four equations based upon the four sink positions of the corner elements, and three unknowns based upon the source position of antenna 116. The three unknowns x, y and z may be solved for which correspond to the coordinate position of the emitting source, antenna 116. Thus, after training is completed, the coordinate position of antenna 116 of target device is known and may be utilized by device 110 to drive each of the antenna elements 210 of antenna array 112 with the proper relative phases in order to transmit RF signal 118 in a beam directed at antenna 116 of target device 114. Thus, antenna array 112 is first trained up in a receiving mode, and then the same antenna weight setting may be used to transmit back to target broadcast device 114. If device 114 also has a phased antenna array, then the training process may be executed in the reverse direction using device 110 as the source and device 114 as the sink. As device 114 moves with respect to device 110, the training sequence phase may be subsequently executed to update device 110 with the new location of antenna 116 so that the relative phases with which to drive antenna elements 210 of antenna array 112 may be updated accordingly.

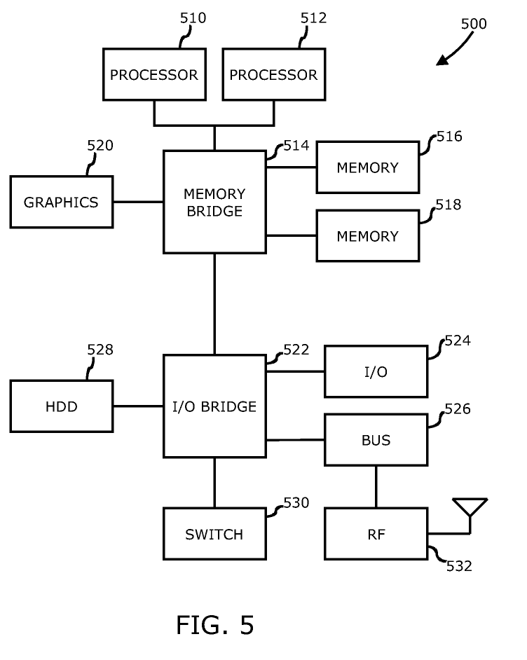

Referring now to FIG. 5, a block diagram of an information handling system capable of using a multilateration estimate of a target device location in accordance with one or more embodiments will be discussed. Information handling system 500 of FIG. 5 may tangibly embody one or more of any of the network elements of network 100 as shown in and described with respect to FIG. 1. For example, information handling system 500 may represent the hardware of receiving device 110 and/or target broadcast device 114, with greater or fewer components depending on the hardware specifications of the particular device or network element. Although information handling system 500 represents one example of several types of computing platforms, information handling system 500 may include more or fewer elements and/or different arrangements of elements than shown in FIG. 5, and the scope of the claimed subject matter is not limited in these respects.

Information handling system 500 may comprise one or more processors such as processor 510 and/or processor 512, which may comprise one or more processing cores. One or more of processor 510 and/or processor 512 may couple to one or more memories 516 and/or 518 via memory bridge 514, which may be disposed external to processors 510 and/or 512, or alternatively at least partially disposed within one or more of processors 510 and/or 512. Memory 516 and/or memory 518 may comprise various types of semiconductor based memory, for example volatile type memory and/or non-volatile type memory. Memory bridge 514 may couple to a graphics system 520 to drive a display device (not shown) coupled to information handling system 500.

Information handling system 500 may further comprise input/output (I/O) bridge 522 to couple to various types of I/O systems. I/O system 524 may comprise, for example, a universal serial bus (USB) type system, an IEEE 1394 type system, or the like, to couple one or more peripheral devices to information handling system 500. Bus system 526 may comprise one or more bus systems such as a peripheral component interconnect (PCI) express type bus or the like, to connect one or more peripheral devices to information handling system 500. A hard disk drive (HDD) controller system 528 may couple one or more hard disk drives or the like to information handling system, for example Serial ATA type drives or the like, or alternatively a semiconductor based drive comprising flash memory, phase change, and/or chalcogenide type memory or the like. Switch 530 may be utilized to couple one or more switched devices to I/O bridge 522, for example Gigabit Ethernet type devices or the like. Furthermore, as shown in FIG. 5, information handling system 500 may include a radio-frequency (RF) block 532 comprising RF circuits and devices for wireless communication with other wireless communication devices and/or via wireless networks such as network 100 of FIG. 1. In one or more embodiments, one or more of processor 510 or processor 512 may comprise and/or implement the functions of a baseband processor for controlling RF block 532. In one or more embodiments, RF block 532 may comprise a transceiver of device 110 and/or device 114, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to fast training of phased arrays using multilateration estimate of the target device location and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
receiving a training signal from a target broadcast device;
determining a relative time difference of arrival for selected antenna elements in an antenna array of antenna elements;
determining a location of the target broadcast device with respect to the antenna array;
determining a propagation time of the training signal with respect to one or more antenna elements in the antenna array; and
converting the propagation time to a phase shift for the elements in the antenna array, wherein a beam generated by the antenna array may be directed or received towards the target device by the elements in the antenna array with the phase shift for the corresponding elements.

2. A method as claimed in claim 1, wherein said determining a relative time difference of arrival for selected antenna elements in an antenna array of antenna elements comprises calculating the time differences between four corner antenna elements of the antenna array.

3. A method as claimed in claim 1, further comprising:
refining the relative time difference of arrival for selected antenna elements in an antenna array of antenna elements by performing a cross correlation using a carrier phase of the training signal.

4. A method as claimed in claim 1, said determining a location of the target device with respect to the antenna array comprising determining the location of the target device with respect to a center of the antenna array via solving Multilateration equations for the location of the target device with respect to coordinates of the antenna array.

5. A method as claimed in claim 1, wherein said determining a propagation time of the training signal with respect to one or more antenna elements in the antenna array comprises calculating the propagation time based at least in part on a distance from the antenna elements and the location of the target device and the speed of light.

6. A method as claimed in claim 1, wherein said converting comprises using a Fourier phase shift property equation to calculate the phase shift for the antenna elements of the antenna array.

7. A method as claimed in claim 1, further comprising:
converting the phase shifts for the antenna elements from a channel frequency of the training signal to a channel frequency of a data signal to be transmitted.

8. An article of manufacture comprising a storage medium having instructions stored thereon that, if executed, result in:
receiving a training signal from a target device;
determining a relative time difference of arrival for selected antenna elements in an antenna array of antenna elements;
determining a location of the target device with respect to the receiving antenna array;
determining a propagation time of the training signal with respect to one or more receiving antenna elements in the antenna array; and
converting the propagation time to a phase shift for the elements in the receiving antenna array, wherein a beam generated by the antenna array may be directed toward the target device by setting the elements in the antenna array with the phase shift for the corresponding elements.

9. An article of manufacture as claimed in claim 8, wherein said determining a relative time difference of arrival for selected antenna elements in an antenna array of antenna elements comprises calculating the time differences between four corner antenna elements of the antenna array.

10. An article of manufacture as claimed in claim 8, wherein the instructions, if executed, further result in:
refining the relative time difference of arrival for selected antenna elements in an antenna array of antenna elements by performing a cross correlation using a carrier phase of the training signal.

11. An article of manufacture as claimed in claim 8, said determining a location of the target device with respect to the receiving antenna array comprising determining the location of the target device with respect to a center of the antenna array via solving Multilateration equations for the location of the target device with respect to coordinates of the receiving antenna array.

12. An article of manufacture as claimed in claim 8, wherein said determining a propagation time of the training signal with respect to one or more antenna elements in the antenna array comprises calculating the propagation time based at least in part on a distance from the antenna elements and the location of the target device and the speed of light.

13. An article of manufacture as claimed in claim 8, wherein said converting comprises using a Fourier phase shift property equation to calculate the phase shift for the antenna elements of the antenna array.

14. An article of manufacture as claimed in claim 8, wherein the instructions, if executed, further result in:
converting the phase shifts for the antenna elements from a channel frequency of the training signal to a channel frequency of a data signal to be transmitted.

15. An apparatus, comprising:
a baseband processor;
a radio-frequency transceiver coupled to said baseband processor; and
an antenna array of antenna elements, the antenna array being coupled to said radio-frequency transceiver, wherein the baseband processor is configured to:
receive a training signal from a target device;
determine a relative time difference of arrival for selected antenna elements in the antenna array of antenna elements;
determine a location of the target device with respect to the antenna array;
determine a propagation time of the training signal with respect to one or more antenna elements in the antenna array; and
convert the propagation time to a phase shift for the elements in the antenna array, wherein a beam generated by the antenna array may be directed toward the target device by setting the elements in the antenna array with the phase shift for the corresponding elements.

16. An apparatus as claimed in claim 15, wherein the determination of a relative time difference of arrival for selected antenna elements in an antenna array of antenna elements comprises calculation of the time differences between four corner antenna elements of the antenna array.

17. An apparatus as claimed in claim 15, wherein the baseband processor is further configured to:
refine the relative time difference of arrival for selected antenna elements in an antenna array of antenna elements by performing a cross correlation using a carrier phase of the training signal.

18. An apparatus as claimed in claim 15, wherein the determination of a location of the target device with respect to the receiving antenna array comprising determination of the location of the target device with respect to a center of the antenna array via solving Multilateration equations for the location of the target device with respect to coordinates of the antenna array.

19. An apparatus as claimed in claim 15, wherein the determination of a propagation time of the training signal with respect to one or more receiving antenna elements in the antenna array comprises calculation of the propagation time based at least in part on a distance from the antenna elements and the location of the target device and the speed of light.

20. An apparatus as claimed in claim 15, wherein the conversion comprises using a Fourier phase shift property equation to calculate the phase shift for the antenna elements of the antenna array.
